(19) United States
(12) Patent Application Publication
(10) Pub. No.: US 2021/0034673 A1
(43) Pub. Date: Feb. 4, 2021

(54) RESOURCE-EFFICIENT CLOSENESS CENTRALITY COMPUTATION IN TIME-EVOLVING GRAPHS

(71) Applicant: SAP SE, Walldorf (DE)

(72) Inventor: Peng Ni, Singapore (SG)

(21) Appl. No.: 16/529,952

(22) Filed: Aug. 2, 2019

(51) Int. Cl. G06F 16/901; G06Q 50/00; G06K 9/62

(52) U.S. Cl. CPC G06F 16/9024; G06K 9/6215; G06Q 50/01

(57) ABSTRACT

Methods, systems, and computer-readable storage media for receiving data representative of time-based snapshots of a time-evolving graph, the data including vertices and edges for each time-based snapshot, for each source vertex in a time-based snapshot: executing a static single-source-shortest-path (SSSP) algorithm to provide a set of distance labels, each distance label including data representative of a distance between the source vertex and a reachable vertex within the time-based snapshot, and determining a total number of reachable vertices from the source vertex within the time-based snapshot and a total distance between the source vertex and the reachable vertices based on the set of distance labels within the time-based snapshot, and providing, for each source vertex, a set of closeness centrality values, each closeness centrality value corresponding to a respective time-based snapshot.

### BACKGROUND

Graphs can include vertices that represent entities and edges that represent relationships between entities. For example, a graph can be provided that represents relationships between users within a network (e.g., a social network), each user being represented as a vertex and a relationship between users being represented as an edge. In some instances, graphs evolve over time. For example, when a user is added to or removed from a network, a respective vertex is added to or removed from a graph representing the network. As another example, when a relationship is added or deleted between users within a network, an edge is added or deleted between vertices representing the users.

Within graphs, values can be generated to represent different characteristics of one or more graph components. An example value includes closeness centrality, which represents a relative importance of a vertex within a network. For example, closeness centrality can be used in social network analytics to identify vertices having significant influence within a social network (e.g., to identify influencers, malicious users, fake users). Because networks, such as social networks, are constantly changing, closeness centralities of vertices are repeatedly calculated to analyze trends in influence vertices may have. However, repetitive calculations can burden technical resources, such as processors and memory used in the calculations.

### SUMMARY

Implementations of the present disclosure are directed to determining closeness centrality of vertices in time-evolving graphs representing networks. More particularly, implementations of the present disclosure are directed to determining closeness centrality by modeling networks as a time-evolving graph and providing a sequence of graph snapshots through time, wherein a closeness centrality of a vertex is computed for each graph snapshot.

In some implementations, actions include receiving data representative of time-based snapshots of a time-evolving graph, the data including vertices and edges for each time-based snapshot, for each source vertex in a time-based snapshot: executing a static single-source-shortest-path (SSSP) algorithm to provide a set of distance labels, each distance label including data representative of a distance between the source vertex and a reachable vertex within the time-based snapshot, and determining a total number of reachable vertices from the source vertex within the time-based snapshot and a total distance between the source vertex and the reachable vertices based on the set of distance labels within the time-based snapshot, and providing, for each source vertex, a set of closeness centrality values, each closeness centrality value corresponding to a respective time-based snapshot. Other implementations of this aspect include corresponding systems, apparatus, and computer programs, configured to perform the actions of the methods, encoded on computer storage devices.

These and other implementations can each optionally include one or more of the following features: the SSSP algorithm provides the set of distance labels by executing a merge label process to selectively merge distance labels of an original set of distance labels and a new set of distance labels to provide the set of distance labels; the merge label process includes a merge-sort based on the time intervals between the original set of distance labels and the new set of distance labels; the time-evolving graph is an insert and/or delete graph and each distance label in the set of distance labels comprises a distance between a respective vertex and the source vertex and a tuple representing a time interval representing a lifespan of an edge; the time-evolving graph is an insert-only graph and distance labels in the set of distance labels are provided as compressed distance labels, each including a distance between a respective vertex and the source vertex and an earliest time that the respective vertex is reachable; each closeness centrality value is calculated as:

$$c [ t ] = \frac{\frac{{( R [ t ] - 1 )}^{2}}{D [ t ]}}{( \vert V \vert - 1 )}$$

where c[t] is the closeness centrality value at time t, R [t] is the total number of reachable vertices from the source vertex at time t, D [t] is the total distance between the source vertex and the reachable vertices at time t, and |V| is the total number of vertices; and the time-evolving graph represents one of a social network and a collaboration network.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2A depicts an example time-evolving graph.

FIG. 2B depicts example graph snapshots of the example time-evolving graph of FIG. 2A.

FIG. 3 depicts an example execution of an Evolving Closeness Centrality (ECC) algorithm in accordance with implementations of the present disclosure.

FIG. 4 graphically depicts an overview of a label merging in accordance with implementations of the present disclosure.

FIG. 5 depicts an example time-evolving graph with only edge insertions.

FIG. 6 depicts an example process that can be executed in accordance with implementations of the present disclosure.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are directed to determining closeness centrality of vertices in time-evolving graphs representing networks. More particularly, implementations of the present disclosure are directed to determining closeness centrality by modeling networks as a time-evolving graph and providing a sequence of graph snapshots through time, wherein a closeness centrality of a vertex is computed for each graph snapshot. Implementations can include actions of receiving data representative of time-based snapshots of a time-evolving graph, the data including vertices and edges for each time-based snapshot, for each source vertex in a time-based snapshot: executing a static single-source-shortest-path (SSSP) algorithm to provide a set of distance labels, each distance label including data representative of a distance between the source vertex and a reachable vertex within the time-based snapshot, and determining a total number of reachable vertices from the source vertex within the time-based snapshot and a total distance between the source vertex and the reachable vertices based on the set of distance labels within the time-based snapshot, and providing, for each source vertex, a set of closeness centrality values, each closeness centrality value corresponding to a respective time-based snapshot.

To provide further context for implementations of the present disclosure, and as introduced above, graphs can include vertices (also referred to as nodes) that represent entities and edges that represent relationships between entities. For example, a graph can be provided that represents relationships between users within a network (e.g., a computer-implemented social network), each user being represented as a vertex and a relationship between users being represented as an edge. In some instances, graphs evolve over time. For example, when a user is added to or removed from a network, a respective vertex is added to or removed from a graph representing the network. As another example, when a relationship is added or deleted between users within a network, an edge is added or deleted between vertices representing the users.

Within graphs, values can be generated to represent different characteristics of one or more graph components. An example value includes closeness centrality, which represents a relative importance of a vertex within a network. For example, closeness centrality can be used in social network analytics to identify vertices having significant influence within a social network (e.g., to identify influencers, malicious users, fake users). Because networks, such as social networks, are constantly changing, closeness centralities of vertices are calculated through time to analyze trends in influence vertices may have. However, repetitive calculations can burden technical resources, such as processors and memory used in the calculations.

In view of the above context, implementations of the present disclosure provide for resource-efficient closeness centrality computation in time-evolving graphs. As described in further detail herein, implementations of the present disclosure model networks as a time-evolving graph and provide a sequence of graph snapshots through time. In some implementations, a closeness centrality of a vertex is computed for each graph snapshot. Implementations of the present disclosure address graphs having vertex and/or edge insertions and deletions and graphs having only vertex and/or edge insertions.

As described in further detail herein, implementations of the present disclosure efficiently utilize graph temporal information, and provide theoretical analysis on its time complexity, which is shown to be small for real-world networks. Experiments on various real-world data sets show that implementations of the present disclosure improve calculation speeds by one to two orders of magnitude compared to traditional techniques (e.g., closeness centrality calculations based on graph topology).

Implementations of the present disclosure are described in further detail with reference to example problem spaces that include social networks (e.g., graphs having vertex and/or edge insertions and deletions) and collaboration networks (e.g., graphs having only vertex and/or edge insertions). It is contemplated, however, that implementations of the present disclosure can be realized in any appropriate problem space.

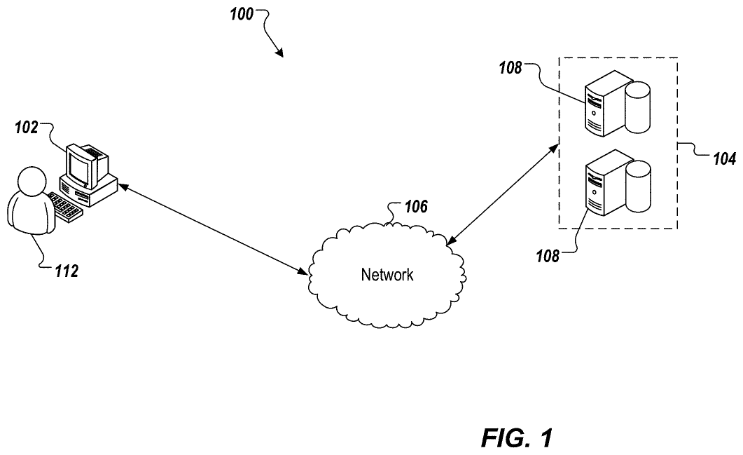

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a network analytics system that provides closeness centrality calculations in accordance with implementations of the present disclosure. For example, the network analytics system can receive data representative of a network (e.g., social network, collaboration network) and can process the data to calculate closeness centrality values in a time- and resource-efficient manner as provided by implementations of the present disclosure.

With regard to the example problem space of social networks, social networks are commonly modelled as a graph, where users and interactions are represented as graph vertices and edges, respectively. The shortest path between two vertices shows how close the users represented by the respective vertices are. The closeness centrality of a vertex is defined as the average shortest path distances to all of its reachable vertices in the graph. Since a vertex with high closeness centrality is able to reach a greater number of vertices in fewer hops, closeness centrality is used as an indicator of vertex importance in graph-based social network.

With the rapid growth and dynamics of social networks, the underlying graph representation has different states at various time instances (e.g., snapshots). This type of graph, having a sequence of graph snapshots, is referred to herein as a time-evolving graph. In such graphs, the shortest path between a pair of vertices can vary from one graph snapshot to another, so the closeness centrality of a vertex is constantly evolving. In accordance with implementations of the present disclosure, and as described in further detail herein, a closeness centrality value of a vertex is determined for each consecutive graph snapshot through time to provide for time-evolving closeness centrality.

Computing time-evolving closeness centrality has numerous applications in network analysis. For example, it can reveal the dynamic change of vertex importance through time. When there is a sudden increase or decrease of the vertex importance, the corresponding graph snapshot can be examined to find related events. Moreover, time-evolving closeness centrality can be a basic building block for more complex analysis, such as finding top-k vertices with the highest centrality values for each graph snapshot.

To compute the time-evolving closeness centrality of a vertex, implementations of the present disclosure utilize incremental shortest path algorithms for dynamic graphs. In some implementations, the shortest paths for the initial snapshot is calculated using a static single-source-shortest-path (SSSP) algorithm and the paths for each set of graph changes are incrementally fixed. In accordance with implementations of the present disclosure, instead of focusing on graph topological similarities in time-evolving graphs, graph temporal features are used to determine time-evolving closeness centrality of a vertex.

As described in further detail, implementations of the present disclosure provide time-aggregated algorithms that each reduce redundant graph traversals. More particularly, graph vertices ordered by distance are traversed, where closer neighbors are visited first before more distant ones. However, implementations of the present disclosure differ from Breadth-First-Search (BFS) in that the same vertex and edge may be visited multiple times. Nevertheless, the number of revisits is relatively low (e.g., less than six) for real-world social network graphs.

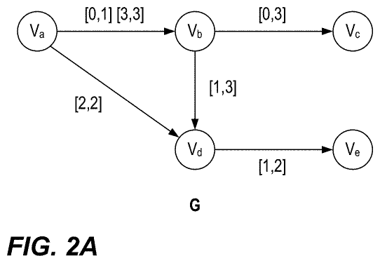

FIG. 2A depicts an example time-evolving graph (G). FIG. 2B depicts example graph snapshots of the example time-evolving graph. In some implementations, G=(V, E, T) represents a time-evolving graph, where V and E are the set of vertices and edges respectively. T is a set of discrete time instances where each t∈T corresponds to a graph snapshot Gₜ at time instance t. An edge e∈E is a tuple (vₒ, v_{d}, Λ), where vₒ, v_{d}∈V are origin and destination vertices, and A⊆T is an ordered list of time intervals denoting the lifespan of the edge, and for each time instance t∈Λ, vₒ points to v_{d} in the corresponding graph snapshot Gₜ. Although the example graph depicted herein is a directed graph, it is contemplated that implementations of the present disclosure can be realized with undirected graphs.

In some implementations, a path p in the time-evolving graph G is defined as a sequence of vertices p= [symbol] v₁, v₂, . . . , vₖ, vₖ₊₁ [symbol] , where (vᵢ, vᵢ₊₁, Λᵢ)∈E is the i-th edge on p for 1≤i≤k. The path is valid at time instance t only if all edges along the path exist at t. Thus, the valid time of a path p, denoted as tᵥ(p), is the intersection of life spans of all edges along the path tᵥ(p)=Λ₁∩ . . . ∩Λₖ. In some examples, d(v, u) denotes the distance between two vertices v and u. Shortest paths in a time-evolving graph are associated with time instances, because the distance d(vₛ, vₜ) between a source vertex vₛ and a target vertex vₜ can vary in different graph snapshots. For example, FIG. 2B shows the distance between vertices vₐ and vₑ for each graph snapshot G₀, G₁, G₂, and G₃. A path p= [symbol] vₛ=v₁, v₂, . . . , vₖ, vₖ₊₁=vₜ [symbol] is a shortest path from source vertex vₛ to target vertex vₜ at time instance t∈tᵥ(p), if ∃/ another path p′= [symbol] vₛ=v₁, v_{2′}, . . . , v_{k′}, v_{k′+1}=vₜ [symbol] , s.t. k′<k and t∈tᵥ(p′).

Equation 1, below, shows the definition of closeness centrality of a vertex v in static graphs. In some examples, R(v) denotes the set of reachable vertices from v and R denotes the size of the set. The farness f(v) of a vertex v is defined as the average distance to reachable vertices, normalized by the ratio of total vertices to reachable ones, and the closeness c(v) is the reciprocal of the farness. This definition takes into consideration that networks are not always wholly connected and can include multiple smaller communities. A vertex from a larger community is expected to have higher closeness centrality score.

$$c ( v ) = \frac{1}{f ( v )} , \\ f ( v ) = \frac{{Σ}_{u ∈ R ( v )} d ( v , u )}{R - 1} \cdot \frac{V - 1}{R - 1} \qquad ( 1 )$$

The evolving closeness centrality of a vertex v in a time-evolving graph is defined to be the sequence of closeness centrality values through time. More specifically, c[t] denotes the closeness centrality of vertex c(v) at time t. Its evolving closeness centrality C is defined in Equation 2 as:

C={c[t₁], c[t₂], . . . , c[tₙ]} where ∪ᵢ₌₁^{n=|T|} tᵢ=T (2)

Accordingly, an evolving closeness centrality query in time-evolving graphs is defined to be: given a time-evolving graph G=(V, E, T) and a source vertex vₛ, find the closeness centrality c [t] of vₛ for each graph snapshot Gₜ (t∈T).

As introduced above, implementations of the present disclosure address graphs having both vertex insertions and deletions and edge insertions and deletions (e.g., graphs representing social networks). Such graphs can be referred to as insert and/or delete graphs. For such graphs, implementations of the present disclosure provide an Evolving Closeness Centrality (ECC) algorithm to compute evolving closeness centrality in general time-evolving graphs with insertions and deletions. The main idea of the ECC algorithm is to traverse graph vertices from shorter to longer distances and associate distance labels with time intervals. However, and unlike conventional BFS, the same vertex can be revisited, because its distances to source vertex can vary for different time instances. Consequently, and in accordance with implementations of the present disclosure, a vertex can appear in more than one BFS level.

Listing 1, below, depicts the ECC algorithm to compute evolving closeness centrality given a source vertex vₛ.

Listing 1: ECC Algorithm

| | Input: Time-evolving graph G(V, E, T), source vertex vₛ | |
|---|---|---|
| | Output: Closeness centrality c[t] for each t ∈ T | |
| 1 | Ł[v].add(∞, [1, \|T\|]) for v ∈ V | [symbol] SSSP |

| 2 | Queue current, next | | | |
|---|---|---|---|---|
| 3 | current.add(vₛ, {(0, [1, \|T\|])}) | | | |
| 4 | while current is not empty do | | | |
| 5 | \| | foreach (v, Lᵥ) in current do | | |
| 6 | \| | \| | (Ł[v], L_{Δ}) = mergeLabels (Ł[v], Lᵥ) | |
| 7 | \| | \| | if L_{Δ} is empty then continue | |
| 8 | \| | \| | foreach edge e(v, u, Λ) from v do | |
| 9 | \| | \| | \| | Lᵤ = {(d + 1, I ∩ Λ) \| ∀(d, I) ∈ L_{Δ}; I ∩ Λ ≠ ∅} |
| 10 | \| | \|_{—} | \|_{—} | if Lᵤ ≠ ∅ then next.add(u, Lᵤ) |
| 11 | \| | current = next | | |
| 12 | \|_{—} | next.clear( ) | | |
| 13 | R[t] = 0, D[t] = 0 for t ∈ T | | | [symbol] Closeness Centrality |
| 14 | foreach vertex v ∈ V do | | | |
| 15 | \| | foreach (d, I) ∈ Ł[v] do | | |
| 16 | \| | \| | if d ≠ ∞ then | |
| 17 | \| | \| | \| | foreach i ∈ I do |
| 18 | \| | \| | \| | \|_ D[i] += d; R[i]++ |

| | \| | \|_{—} | \| |
|---|---|---|---|
| | \|_{—} | | |
| 19 | foreach t ∈ [1, \|T\|] do | | |
| 20 | | \| | if D[t] = 0 then c[t] = 0 |
| 21 | | \|_{—} | else c[t] = (R[t] − 1)² / D(t] / (\|V\| − 1) |

| | |
|---|---|
| 22 | return c[t] for each t ∈ T |

The input to the ECC Algorithm is an aggregated graph representation that accounts for changes over time. Using the example of FIG. 2A as a non-limiting example, the input can be represented as:
Vertices: a, b, c, d, e
Edges:
a, b, [0,1][3,3]
a, d, [2,2]
b, c, [0,3]
b, d, [1,3]
d, e, [1,2]

As seen, the ECC Algorithm first runs a SSSP algorithm from vₛ to calculate the distance labels Ł[v] for each reachable vertex v, as shown in lines 1-12. Then, the number of reachable vertices and sum of distances for each snapshot is computed based on Ł[v], in lines 13-18. Finally, the closeness centrality c[t] for each snapshot is computed based on Equation 1, above. To make the distance data structure more compact, if a vertex's distance does not change over a time interval I=[tₛ, tₑ] (e.g., time start, time end), a distance label (d, I) is used to denote the distance is d for all time instances t∈I. The ECC algorithm correctly computes the distance labels Ł[v] for each vertex v∈V for each graph snapshot Gₛ, s∈T. Table 1, below, summarizes notations used in Listing 1.

TABLE 1
Summary of Notations in Listing 1

| Notation | Definition and Description |
|---|---|
| (d, I) | A label with a distance d and a time interval I |
| L | A list of distance labels {(d₁, I₁), . . . } |
| Ł[v] | The tentative distance labels for vertex v |
| 1, \|T\| | Minimum and maximum time instance in T, without loss of generality |
| current | Queue of pairs (v, L) for current BFS level |
| next | Queue of pairs (v, L) for next BFS level |
| R[t] | Total number of reachable vertices from source vertex at snapshot Gₜ |
| D[t] | Sum of distance to all vertices from source vertex at snapshot Gₜ |

In some implementations, queues current and next are maintained, corresponding to the vertices for the current and next BFS level. Note that the element in the queue is a pair (v, L), which includes a vertex v and associated list of distance labels L. In an initialization phase, all vertices are assigned an infinite distance for all time instances (∞, [1, |T|]). Then the source vertex and its initial label (vₛ, {(0, [1, |T|])}) is added to the current queue.

In each iteration, a vertex v with its newly identified labels Lᵥ is retrieved from the current queue. Then Lᵥ is merged into vertex v's existing labels Ł[v], such that any improved label is copied into L_{Δ} to update v's neighbors in later iterations. This mergeLabels process can be done using mergesort-like operations in linear time, as described in further detail herein. If L_{Δ} is empty, vertex v's labels are not improved and the next element in current queue is processed. Otherwise, the new labels L_{Δ} of v is propagated to its neighbors. For each neighbor u of v, its labels Lᵤ is computed, by intersecting v's labels and the time intervals of edge e using mergesort-like operations, as shown in line 9 of Listing 1. For each of vertex v's new label (d, I)∈L_{Δ}, its time interval I is intersected with the life span of the edge Λ. Then Lᵤ is constructed by increasing the distance by 1 and taking the intersected time interval {(d+1, I∩Λ)}. If the resulting labels Lᵤ are not empty, vertex u is added with its labels Lᵤ to the next queue.

When all elements in the current queue are processed, current is swapped with next and the next iteration is performed. The graph traversal stops when current queue becomes empty. Then the distance from source vₛ to each vertex v∈V for each graph snapshot Gₜ, t∈T are computed. In Gₜ, a vertex v is reachable, if and only if its distance is not infinity. The closeness centrality of vertex vₛ at snapshot Gₜ can be computed based on the number of reachable vertices R[t] and the sum of all distances D[t] using Equation 1, above.

At a high-level, and using the time-evolving graph of FIG. 2A as an example, the ECC Algorithm performs the following considering vertex a as the source vertex:
1. Initially vertex a has a label of (0, [0, 3])→meaning distance=0 for time interval [0, 3].
2. BFS level 1:
   a. Following edge a, b, [0, 1][3, 3], vertex b has label (1, [0, 1]) and (1, [3, 3])
   b. Following edge a, d, [2, 2], vertex d has label (1, [2, 2])
3. BFS level 2:
   a. Following edge b, c, [0, 3], vertex c has label (2, [0, 1]) and (2, [3, 3])
   b. Following edge b, d, [1, 3], vertex d has label (2, [1, 1]) and (2, [3, 3])
   c. Following edge d, e, [1, 2], vertex e has label (2, [2, 2])
4. BFS level 3:
   a. Following edge d, e, [1, 2], vertex e has label (3, [1, 1])
      The time intervals associated with each edge indicate in which snapshots the edge exists. The time intervals associated with distance labels indicate in which snapshots the distance is feasible.

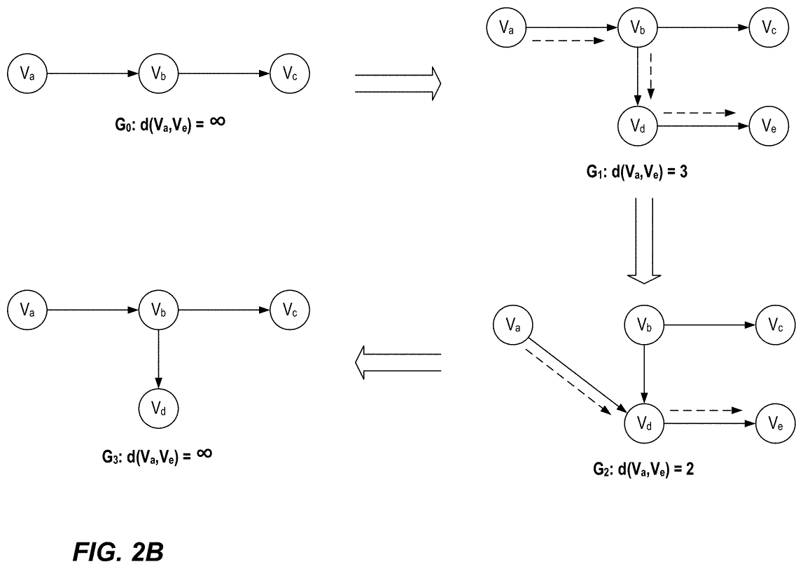

FIG. 3 depicts an example execution of the ECC algorithm from source vertex vₐ to compute Ł[v] in the time-evolving graph of FIG. 2A. Initially, the source vertex vₐ with label (0, [0,3]) is added in the current queue. In the first BFS level, traversing outgoing edges from vₐ generates the label (1, [0,1]), (1, [3,3]) for vertex v_{b} and label (1, [2,2]) for vertex v_{d}. In BFS level 2, outgoing edges from v_{b} update v_{c}'s labels to be (2, [0,1])(2, [3,3]) and v_{d} is updated again to include labels (2, [1,1]) and (2, [3,3]). The outgoing edge from v_{d} gives vₑ label (2, [2,2]). In BFS level 3, the outgoing edge from v_{d} updates vₑ again to include label (3, [1,1]), and the graph traversal stops.

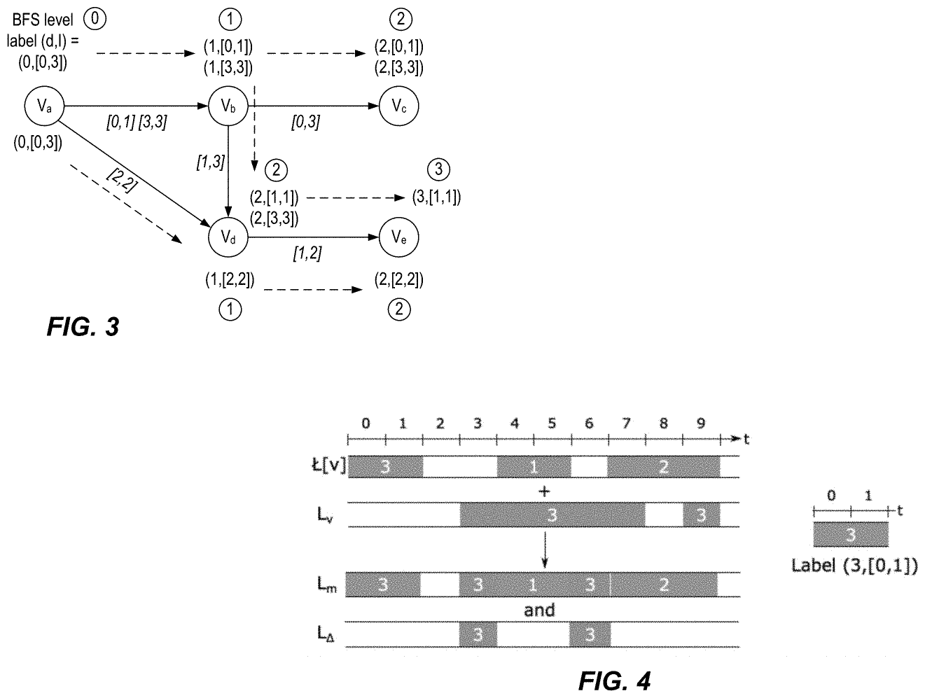

As introduced above, implementations further provide a label merge process, as indicated in line 6 of Listing 1. More particularly, when a list of newly generated labels Lᵥ for a vertex v in the current queue is provided, non-dominated labels L_{Δ} are determined and are merged into existing labels Ł[v]. The label merge process takes two lists of labels, original labels Ł[v] and the labels to be added Lᵥ as input parameters. It will merge the two lists and generate a new label Lₘ, which replaces Ł[v] to reflect the updates on the original labels. All inserted labels that are not previously in Ł[v] will be added to L_{Δ}. To develop an efficient process, two important observations are leveraged. First, the distance labels in Lᵥ are of the same value, which is equal to the corresponding BFS level. Second, the distance value in Lᵥ is larger or equal to the largest distance value in Ł[v]. This is because vertices from lower BFS levels are traversed to higher BFS levels. Thus, the distance cannot decrease. With these two observations, when we merge labels, we do not need to compare the distances associated with time intervals from Ł[v] and Lᵥ, because the distance from Ł[v] always dominates Lᵥ. Consequently, implementations of the present perform a merge-sort on the time intervals from Ł[v] and Lᵥ. FIG. 4 graphically depicts an overview of mergeLabels: ( [symbol] [v], Lᵥ) [symbol] (Lₘ, L_{Δ})

In accordance with implementations of the present disclosure, the time complexity of the SSSP computation (lines 1-12 of the ECC Algorithm) is O(K²·(|V|+|E|)), where K is the maximum number of distance labels of a vertex. In the ECC algorithm, a vertex may be revisited due to multiple distance labels, and the number of visits is bounded by its maximum number of distance labels K. In each visit, mergeLabels has a time complexity of O(K) (in line 6). Thus, the time complexity associated with vertex computation in the ECC Algorithm is O(K²·|V|). Similarly, each edge may be visited at most K times, and for each visit, label computation has a time complexity of O(K) (line 9). Thus, the time complexity for edge computation is O(K²·|E|). Accordingly, the total time complexity for the computation of SSSP (lines 1-12) is O(K²·(|V|+|E|)).

As also introduced above, implementations of the present disclosure also address graphs having only vertex and/or edge insertions (e.g., graphs representing collaboration networks). Such graphs can be referred to as insert-only graphs. For such graphs, implementations of the present disclosure provide an Evolving Closeness Centrality Insert-Only (ECCI) algorithm to compute evolving closeness centrality in general time-evolving graphs with edge and/or node insertions only.

For example, in many real-world networks, such as DBLP scientific collaboration network and the IMDB movie costar network, nodes and edges, once inserted, are not deleted. To address such graphs, the ECCI Algorithm is optimized to simplify the mergeLabels process by using compressed distance labels, and to aggregate updates on the total number of reachable vertices and sum of distances (i.e., R[t] and D[t]) at the end of each BFS level during graph traversals, instead of using individual vertex distance labels Ł[v], as used in the ECC algorithm.

In further detail, and as discussed above, a vertex v has a list of distance labels Ł[v], where each label is a distance, time interval pair (d, I). Since the time-evolving graph addressed by the ECCI Algorithm has only vertex or edge insertions, its distance to source vertex can only be reduced over time. Consequently, the distance labels can be compressed in the form {(d₁, t₁), (d₂, t₂), . . . (dₙ, tₙ)} where 1≤t₁<t₂ . . . <tₙ≤|T| and d₁>d₂ . . . >dₙ. Intuitively, this means the vertex first becomes connected to the source vertex at the time instance t₁, with a distance d₁. Due to insertions of new edges, the distance is reduced to d₂ at time instance t₂, until the distance finally becomes dₙ at time tₙ. The set of labels of a vertex is distance-time Pareto-optimal (i.e., ∀(dᵢ, tᵢ), (dⱼ, tⱼ) in the set, dᵢ>dⱼ iff tᵢ<tⱼ).

During the vertex traversals in the ECC Algorithm, the distance d of generated labels (d, t) is non-decreasing, so the labels of a vertex v will be traversed in descending time order (and ascending distance order). Then the mergeLabels process can be simplified. When a new label (d, t) is generated for vertex v, it only needs to be compared with the last label (d′, t′). If t<t′, (d, t) is not dominated by the existing labels in the set.

In the ECCI Algorithm of the present disclosure, tₘ[v] is used to store the current earliest time that vertex v is reachable, with the initial value set to be ∞. Since the distance of a label is always equal to the BFS level, only the vertex and time information is stored in current and next queues. When an element (v, t) is retrieved from current queue and mergeLabels at BFS level d is performed, only a simple check whether t<tₘ[v] is required. If positive, the label (d, t) should be included in vertex v's label set, and tₘ[v] is updated to be t accordingly.

In some implementations, the time complexity of SSSP computation in the insertion-only graph is reduced to O(K·(|V|+|E|)) from O(K²·(|V|+|E|)) in the insert and/or delete graph. More particularly, time complexity of mergeLabels in the ECC Algorithm is O(1) if compressed labels are used. In line 9 of the ECC Algorithm, the label for the next vertex u is computed. Since L_{Δ} only has a single label, the time complexity is also O(1). Consequently, the time complexity of SSSP is O(K·(|V|+|E|)) in the ECCI Algorithm.

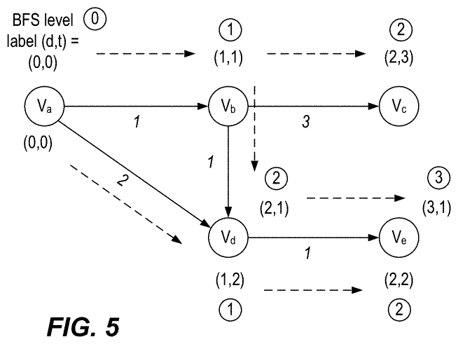

FIG. 5 depicts an example time-evolving graph with only edge insertions. Each edge is associated with a number representing the first-time instance that the edge becomes available. The source vertex vₐ has a single label (0,0). Following outgoing edges from vₐ, the label (1,1) for vertex v_{b} and (1,2) for vertex v_{d}, and their earliest reachable time tₘ[v_{b}] and tₘ[v_{d}] are updated from ∞ to 1 and 2, respectively. When the edge is traversed from v_{b} to v_{d}, label (2,1) is generated. Because the new reachable time 1 is smaller than 2, this label should be kept and we update tₘ[v_{b}]=1.

In some implementations, the vertex reachability information is aggregated. The updates for R[t] and D[t] are performed only once at the end of each BFS level instead of being updated whenever a new label in Ł[v] is found. In some examples, all vertices identified in the d-th level have the same distance to source vertex, which is exactly d.

In some implementations, for each BFS level, two counts Vₘ[t] and V[t] for each graph snapshot t∈T are kept. Vₘ[t] is used to count the total number of new vertices whose earliest reachable time tₘ[v] is updated to be t in this level, and V[t] is a cumulative count for total number of new vertices for time t, which includes vertices whose earliest reachable time is updated to be smaller than or equal to t, i.e., V[t]=Σₓ₌ₜ_{ₘᵢₙ}^{t}Vₘ[x]. At the end of BFS level d, R[t] and D[t] are updated based on V[t]: the number of reachable vertices R[t] at time t is increased by exactly V[t], and sum of distances D[t] is increased by d*V[t].

In BFS level d, when there is a new label (d, t) for vertex v, Vₘ[t] is updated in two different ways based on vertex v's existing earliest reachable time tₘ[v]. If tₘ[v]=∞, this is the first time v is reached, so R[t] and D[t] for snapshots from t to tₘₐₓ are updated. In this case, Vₘ[t] is increased by 1. However, if tₘ[v] is not ∞, the vertex has been discovered before, but now it has an earlier reachable time. In this case, only R[t] and D[t] are updated for snapshots from t to tₘ[v]−1, because snapshots tₘ[V] to tₘₐₓ have already been updated previously. Consequently, Vₘ[tₘ[v]] is first decreased by 1 to avoid duplicate updates on snapshots after tₘ[v]. Then, Vₘ[t] is increased by 1. Because the counter Vₘ(t) is updated whenever a label is generated and R[t] and D[t] are updated incrementally at the end of each BFS level, there is no longer a need to save all vertex labels Ł[v].

The time complexity to calculate R[t] and D[t] is improved to O(|V|·K+B·|T|) from O(|V|·|T|), where K is the maximum number of labels of a vertex, and B is the maximum BFS level. For a vertex with K labels, one update is needed on Vₘ[t] when it is discovered for the first time, and two updates for each K−1 labels on Vₘ[t]. The total number of updates on Vₘ[t] for a vertex is 2K−1. The number of updates on V[t], R[t] and D[t] is T for each BFS level. Consequently, the total number of update operations is V·(2K−1)+B·3|T|=O(|V|·K+B·|T|).

Listing 2, below, depicts the ECCI Algorithm to compute evolving closeness centrality given a source vertex vₛ, and Table 2, below, summarizes notations used in Listing 2.

Listing 2: ECCI Algorithm

| | Input: Time-evolving graph G(V, E, T), source vₛ | | | |
|---|---|---|---|---|
| | Output: Closeness centrality c[t] for each t ∈ T | | | |
| 1 | R[t] = 0, D[t] = 0 for t ∈ T | | | |
| 2 | tₘ[v] = ∞ for v ∈ V | | | |
| 3 | Queue current, next | | | |
| 4 | current.add((v₃, 1)) | | | |
| 5 | level = 0 | | | |
| 6 | while current is not empty do | | | |
| 7 | \| | Vₘ[t] = 0 for t ∈ T | | |
| 8 | \| | foreach label (v, t) in current do | | |
| 9 | \| | \| | if tₘ[v] ≤ t then continue | |
| 10 | \| | \| | Vₘ[t]++ | |
| 11 | \| | \| | if tₘ[v] ≠ ∞ then Vₘ[tₘ[v]]−− | |
| 12 | \| | \| | tₘ[v] = t | |
| 13 | \| | \| | foreach edge e(v, u, t′) form v do | |
| 14 | \| | \| | \| | tᵤ = max(t, t′) |
| 15 | \| | \| | \| | if tᵤ < tₘ[u] then next.add((u, tᵤ)) |

| 16 | \| | V[t] = 0 | |
|---|---|---|---|
| 17 | \| | foreach t ∈ [1, \|T\|] do | |
| 18 | \| | \| | V[t] += Vₘ[t] |
| 19 | \| | \| | R[t] += V[t] |
| 20 | \| | \|_{—} | D[t] += level * V[t] |

| | | |
|---|---|---|
| 21 | \| | current = next |
| 22 | \| | next.clear( ) |
| 23 | \| | level++ |

| 24 | foreach t ∈ [1, \|T\|] do | |
|---|---|---|
| 25 | \| | if D[t] = 0 then c[t] = 0 |
| 26 | \| | else c[t] = (R[t] − 1)² / D[t] / (\|V\| − 1) |

| | |
|---|---|
| 27 | return c[t] for each time instance t ∈ T |

TABLE 2
Summary of Notations in Listing 2

| Variable | Definition and Description |
|---|---|
| tₘ[v] | Current earliest time that vertex v is reachable |
| Vₘ[t] | # vertices whose earliest reachable time tₘ[v] = t |
| V[t] | # vertices reachable up to time t |

In accordance with the ECCI Algorithm of the present disclosure, tₘ[v] is used to store the current earliest reachable time for vertex v. Initially, the value is set to be infinity for all vertices. The current and next queue now holds elements in the form of (vertex, time), and initially the source vertex with starting time 1 is added in the current queue. In each BFS iteration, the elements in the current queue are examined. For a vertex v with time t, if v's reachable time is already earlier than t, the element is skipped and moved to the next one in the current queue. Otherwise, the number of vertices Vₘ[t] discovered at time instance t is increased by 1. It is determined whether tₘ[v] is infinity. If not, it means v has been discovered before. In response, Vₘ[tₘ[v]] is decreased by 1 to avoid duplicate updates.

For each outgoing edge (v, u, t′), the new reachable time tᵤ for vertex u is the maximum of t and t′. If tᵤ is smaller than the current earliest reachable time tₘ[u] of u, the label (u, tᵤ) is added to the next queue. In lines 16-20 of Listing 2, the total number of new vertices V[t] for each time t is counted, and it increases R[t] and D[t] by V[t] and level*V[t] respectively. In lines 24-26 of Listing 2, the centrality value c[t] is calculated for each snapshot based on total distance D[t] and number of reachable vertices R[t].

Table 3, below, summarizes the time complexity of the ECC Algorithm and the ECCI Algorithm of the present disclosure. It can be found that the performance of SSSP algorithm is dependent on K, the maximum number of times that the distance can change for a vertex. When graphs have a larger number of graph snapshots, K may also increase. For real-world social network graphs with insertions only, a vertex's distance label is Pareto-optimal in terms of time and distance. Consequently, the maximum number of labels is less than or equal to the maximum distance. Because the distance between two reachable vertices is usually less than 6 for social networks (due to the observation of six degrees of separation, or popularly known as the ‘small-world phenomenon’), K is also relatively small. For graphs with edge deletions, in real-world scenarios, the percentage of deletions is usually small (e.g., 5% to 15%) and the number of labels will not change significantly. Empirical studies (summarized below) have shown that the number of labels is indeed very small, usually smaller than 2 for real-world graphs.

TABLE 3
Summary of Time Complexities

| Algorithm | SSSP | Closeness Centrality Updates |
|---|---|---|
| ECC | 0(K² · (\|V\| + \|E\|)) | 0(\|T\| · \|E\|) |
| ECCI | 0(K · (\|V\| + \|E\|)) | 0(K · \|V\| + \|T\| · B) |

Implementations of the present discourse achieve technical advantages over traditional techniques. Example traditional techniques are referred to herein as baseline algorithms and include both offline (pre-processing) and online approaches. An example online approach utilizes dynamic single-source-shortest-path algorithm (DSSSP), by first issuing a SSSP request to G₁ and computing vertex distances for all vertices at time instance t₁ to compute c[1]. For each following graph snapshot Gₜ, DSSSP is used to update vertex distances Lₜ^{t} for each edge insertion and deletion. When all changes are accommodated, c[t] is computed. DSSSP is used as a comparison algorithm for both ECCI and ECC. An example offline approach includes the historical pruned landmark labeling algorithm (HPLL). Given a time-evolving graph, HPLL first performs preprocessing and generates two-hops labels. For each pair of vertices, HPLL can find the distance between them for all snapshots using change-point queries. After preprocessing, for each vertex v∈V, a change-point query is issued from source vₛ to v and update Labels Łᵥ (the same data structure as in ECC), and c[t] is computed for each t∈T using Łᵥ. Because HPLL only supports edge insertions, it is compared only to ECCI.

In the empirical studies, ECCI, ECC and DSSSP are implemented in Java 8. HPLL (in C++) is extended to support directed graphs, compiled using gcc 8.1.0 with O3 flag. The experiments were executed on an Intel Xeon Processor E5-2695 v2. Further, four real-world data sets were used and include: IMDB movie data (imdb) representing an actor collaboration network; youtube-d-growth (youtube) representing a youtube followers network; dblp-2018-01-01 (dblp) representing a computer science coauthor network; and wikipedia-growth (wikipedia) representing a Wikipedia hyperlink reference networks. In each these four real-world graphs, there is no edge deletion, and performance of ECCI, HPLL and Dynamic SSSP.

A graph was created from each of the example real-world data sets. For each graph, 100 source vertices were randomly selected and evolving centralities were computed for each vertex. To compare performance, a total elapsed time was determined for each algorithm. The experimental results show that ECCI outperforms both DSSSP and HPLL by an order of magnitude for all data sets. With regard to HPLL, in particular, ECCI has the advantage that no preprocessing is needed. The experimental results also show that the average number of labels for each vertex is below 2 for all graphs.

Experiments were also conducted using synthetic data sets with similar scale-free characteristics as the real-world graphs described above. The topological size (number of vertices and edges) and temporal size (number of snapshots) were varied to further verify the performance impact of various topological and temporal graph features.

For the experiments, synthetic graphs are generated in two steps. First, Recursive MATrix (RMAT) static scale-free graphs are generated with edge factor 16 (i.e., the average number of adjacent edges per vertex is around 16). The number of vertices in the graphs ranges from Scale 17 to Scale 21, where Scale N means the graph includes around 2^{N} vertices. The largest graph, Scale 21, has a similar size as the wikipedia-growth graph, with 1.2 million vertices and 31.8 million edges. Second, for each static edge, the edge is associated with a random starting time from 0 to a maximum snapshot size |T|.

For the first set of experiments, the impact of graph size is studied by experimenting on all 5 synthetic data set with |T|=2000. For each graph, 100 source vertices are randomly selected to compute evolving centralities. ECCI outperformed DSSSP by two orders of magnitude and outperforms HPLL by one order of magnitude. Moreover, the performance gain compared to baseline algorithms generally increases as the graph size doubles each time. The average number of labels is still below 2 for all graphs, which is one factor contributing to the better performance of ECCI.

To study the impact of a number of time instances on computation time, the graph size is fixed to be the largest synthetic graph Scale 21. Then 5 time-evolving graphs were created with |T| ranging in [500, 1000, 2000, 4000, 8000]. As the number of graph snapshots grows, the performance gain of ECCI increases when compared to DSSSP, due to many more edge insertions to handle for DSSSP. The speedup compared to HPLL is relatively stable, and the average label size is still very small.

Experiments also included random edge deletions in the synthetic graphs. For each graph snapshot, 5%, 10% and 15% the size of newly inserted edges are removed by selecting edges randomly from all remaining edges. The percentage is kept low to reflect the real-world scenario that there are far more edge insertions than deletions in, for example, online social networks. A first experiment fixed the graph topology size as Scale 21 and the number of snapshots as 2000, and varied the percentage of edge deletions from 5% to 15%. The performance gain of ECC over DSSSP is stable and about 7 times faster for all three cases. The average number of labels are 2.55, 2.66 and 2.76 for deletions of 5%, 10% and 15% respectively. A second experiment fixed the graph number of snapshots as 2000 and edge deletions to 5%, and varied the graph topology size from Scale 17 to 21. The performance gain of ECC over DSSSP ranged from 5.6 to 11.1 and the average number of labels ranged from 2.12 to 2.64. The best performance improvement of ECC over DSSSP is achieved at graph Scale 19. It has the lowest average number of labels 2.12, which may be due to the randomness of the sampled queries. A third experiment fixed the graph topology as Scale 21 and the edge deletions to 5%, and varied the graph snapshot sizes from 500 to 8000. The performance gain of ECC over DSSSP ranged from 4.3 to 12.4 and is increasing with the number of snapshots. The average number of labels range from 2.42 to 2.51, so ECC has a similar workload for all cases. In comparison, the DSSSP has a much larger workload for graphs with large snapshots due to the increasing total number of edge deletions to process.

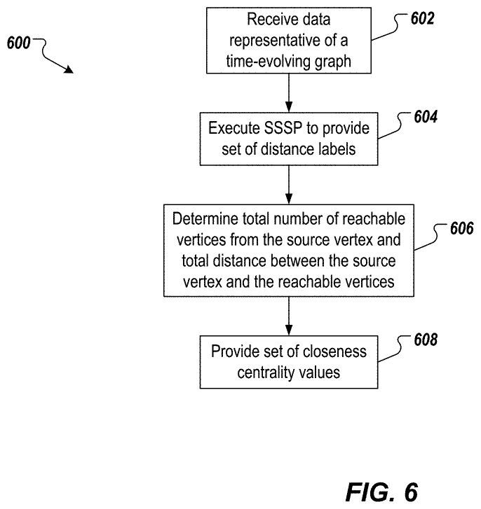

FIG. 6 depicts an example process 600 that can be executed in accordance with implementations of the present disclosure. In some examples, the example process 600 is provided using one or more computer-executable programs executed by one or more computing devices.

Data representative of time-based snapshots of a time-evolving graph is received (602). For example, a network analytics system hosted on the server system 104 of FIG. 1 can receive the data representative of a time-evolving graph. In some examples, the data represents vertices and edges for each time-based snapshot. For example, and as described above using FIG. 2A as a non-limiting example, the data representative of a time-evolving graph can be provided as:
Vertices: a, b, c, d, e
Edges:
a, b, [0,1][3,3]
a, d, [2,2]
b, c, [0,3]
b, d, [1,3]
d, e, [1,2]
   In some examples, the time-evolving graph represents one of a social network and a collaboration network.

For each source vertex in the data, a SSSP algorithm is executed to provide a set of distance labels (604). In some examples, each distance label includes data representative of a distance between the source vertex and a reachable vertex within a time-based snapshot. In some examples, the SSSP algorithm provides the set of distance labels by executing a merge label process to selectively merge distance labels of an original set of distance labels and a new set of distance labels to provide the set of distance labels. In some examples, the merge label process includes a merge-sort based on the time intervals between the original set of distance labels and the new set of distance labels. In some examples, the time-evolving graph is an insert and/or delete graph and each distance label in the set of distance labels includes a distance between a respective vertex and the source vertex and a tuple representing a time interval representing a lifespan of an edge. In some examples, the time-evolving graph is an insert-only graph and distance labels in the set of distance labels are provided as compressed distance labels, each includes a distance between a respective vertex and the source vertex and an earliest time that the respective vertex is reachable.

For each source vertex in a time-based snapshot, a total number of reachable vertices from the source vertex within the time-based snapshot and a total distance between the source vertex and the reachable vertices are determined (606). For example, and as described in detail herein, each is determined based on the set of distance labels. A set of closeness centrality values is provided for each source vertex (608). As described in detail herein, each closeness centrality value corresponding to a respective time-based snapshot. In some examples, each closeness centrality value is calculated as:

$$c [ t ] = \frac{\frac{{( R [ t ] - 1 )}^{2}}{D [ t ]}}{( \vert V \vert - 1 )}$$

where c[t] is the closeness centrality value at time t, R[t] is the total number of reachable vertices from the source vertex at time t, D[t] is the total distance between the source vertex and the reachable vertices at time t, and |V| is the total number of vertices.

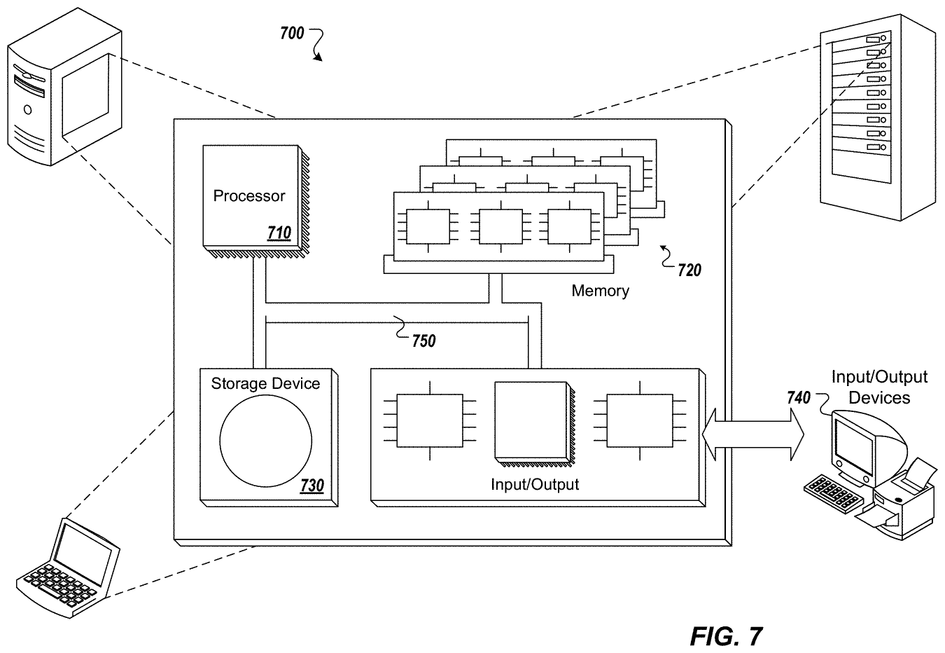

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for determining closeness centrality of vertices in time-evolving graphs, the method being executed by one or more processors and comprising:
receiving data representative of a time-evolving graph, the data comprising vertices and edges, each edge comprising time interval information that can be used to distinguish time-based snapshots;
for each source vertex in the data:
executing a static single-source-shortest-path (SSSP) algorithm to provide a set of distance labels, each distance label comprising data representative of a distance between the source vertex and a reachable vertex within a time-based snapshot, and
determining a total number of reachable vertices from the source vertex within the time-based snapshot and a total distance between the source vertex and the reachable vertices based on the set of distance labels within the time-based snapshot; and
providing, for each source vertex, a set of closeness centrality values, each closeness centrality value corresponding to a respective time-based snapshot.

2. The method of claim 1, wherein the SSSP algorithm provides the set of distance labels by executing a merge label process to selectively merge distance labels of an original set of distance labels and a new set of distance labels to provide the set of distance labels.

3. The method of claim 2, wherein the merge label process comprises a merge-sort based on the time intervals between the original set of distance labels and the new set of distance labels.

4. The method of claim 1, wherein the time-evolving graph is an insert and/or delete graph and each distance label in the set of distance labels comprises a distance between a respective vertex and the source vertex and a tuple representing a time interval representing a lifespan of an edge.

5. The method of claim 1, wherein the time-evolving graph is an insert-only graph and distance labels in the set of distance labels are provided as compressed distance labels, each comprising a distance between a respective vertex and the source vertex and an earliest time that the respective vertex is reachable.

6. The method of claim 1, wherein each closeness centrality value is calculated as:
$$c [ t ] = \frac{\frac{{( R [ t ] - 1 )}^{2}}{D [ t ]}}{( \vert V \vert - 1 )}$$
where c[t] is the closeness centrality value at time t, R[t] is the total number of reachable vertices from the source vertex at time t, D[t] is the total distance between the source vertex and the reachable vertices at time t, and |V| is the total number of vertices.

7. The method of claim 1, wherein the time-evolving graph represents one of a social network and a collaboration network.

8. A non-transitory computer-readable storage medium coupled to one or more processors and having instructions stored thereon which, when executed by the one or more processors, cause the one or more processors to perform operations for determining closeness centrality of vertices in time-evolving graphs, the operations comprising:
receiving data representative of a time-evolving graph, the data comprising vertices and edges, each edge comprising time interval information that can be used to distinguish time-based snapshots;
for each source vertex in the data:
executing a static single-source-shortest-path (SSSP) algorithm to provide a set of distance labels, each distance label comprising data representative of a distance between the source vertex and a reachable vertex within a time-based snapshot, and
determining a total number of reachable vertices from the source vertex within the time-based snapshot and a total distance between the source vertex and the reachable vertices based on the set of distance labels within the time-based snapshot; and
providing, for each source vertex, a set of closeness centrality values, each closeness centrality value corresponding to a respective time-based snapshot.

9. The computer-readable storage medium of claim 8, wherein the SSSP algorithm provides the set of distance labels by executing a merge label process to selectively merge distance labels of an original set of distance labels and a new set of distance labels to provide the set of distance labels.

10. The computer-readable storage medium of claim 9, wherein the merge label process comprises a merge-sort based on the time intervals between the original set of distance labels and the new set of distance labels.

11. The computer-readable storage medium of claim 8, wherein the time-evolving graph is an insert and/or delete graph and each distance label in the set of distance labels comprises a distance between a respective vertex and the source vertex and a tuple representing a time interval representing a lifespan of an edge.

12. The computer-readable storage medium of claim 8, wherein the time-evolving graph is an insert-only graph and distance labels in the set of distance labels are provided as compressed distance labels, each comprising a distance between a respective vertex and the source vertex and an earliest time that the respective vertex is reachable.

13. The computer-readable storage medium of claim 8, wherein each closeness centrality value is calculated as:
$$c [ t ] = \frac{\frac{{( R [ t ] - 1 )}^{2}}{D [ t ]}}{( \vert V \vert - 1 )}$$
where c[t] is the closeness centrality value at time t, R[t] is the total number of reachable vertices from the source vertex at time t, D[t] is the total distance between the source vertex and the reachable vertices at time t, and |V| is the total number of vertices.

14. The computer-readable storage medium of claim 8, wherein the time-evolving graph represents one of a social network and a collaboration network.

15. A system, comprising:
a computing device; and
a computer-readable storage device coupled to the computing device and having instructions stored thereon which, when executed by the computing device, cause the computing device to perform operations for determining closeness centrality of vertices in time-evolving graphs, the operations comprising:
receiving data representative of a time-evolving graph, the data comprising vertices and edges, each edge comprising time interval information that can be used to distinguish time-based snapshots;
for each source vertex in the data:
executing a static single-source-shortest-path (SSSP) algorithm to provide a set of distance labels, each distance label comprising data representative of a distance between the source vertex and a reachable vertex within a time-based snapshot, and
determining a total number of reachable vertices from the source vertex within the time-based snapshot and a total distance between the source vertex and the reachable vertices based on the set of distance labels within the time-based snapshot; and
providing, for each source vertex, a set of closeness centrality values, each closeness centrality value corresponding to a respective time-based snapshot.

16. The system of claim 15, wherein the SSSP algorithm provides the set of distance labels by executing a merge label process to selectively merge distance labels of an original set of distance labels and a new set of distance labels to provide the set of distance labels.

17. The system of claim 16, wherein the merge label process comprises a merge-sort based on the time intervals between the original set of distance labels and the new set of distance labels.

18. The system of claim 15, wherein the time-evolving graph is an insert and/or delete graph and each distance label in the set of distance labels comprises a distance between a respective vertex and the source vertex and a tuple representing a time interval representing a lifespan of an edge.

19. The system of claim 15, wherein the time-evolving graph is an insert-only graph and distance labels in the set of distance labels are provided as compressed distance labels, each comprising a distance between a respective vertex and the source vertex and an earliest time that the respective vertex is reachable.

20. The system of claim 15, wherein each closeness centrality value is calculated as:
$$c [ t ] = \frac{\frac{{( R [ t ] - 1 )}^{2}}{D [ t ]}}{( \vert V \vert - 1 )}$$
where c[t] is the closeness centrality value at time t, R[t] is the total number of reachable vertices from the source vertex at time t, D[t] is the total distance between the source vertex and the reachable vertices at time t, and |V| is the total number of vertices.
